(19) United States
(12) Patent Application Publication
(10) Pub. No.: US 2021/0032464 A1
(43) Pub. Date: Feb. 4, 2021

(54) IMPACT-MODIFIED POLYAMIDE MOULDING COMPOUNDS

(71) Applicant: EMS-PATENT AG, Domat/Ems (CH)

(72) Inventor: Georg STÖPPELMANN, Bonaduz (CH)

(73) Assignee: EMS-PATENT AG, Domat/Ems (CH)

(21) Appl. No.: 16/956,564

(22) PCT Filed: Dec. 6, 2018
(86) PCT No.: PCT/EP2018/083822

§ 371 Date: Jun. 20, 2020

(30) Foreign Application Priority Data
Dec. 22, 2017 (EP) 17210006.7

(51) Int. Cl. C08L 77/06; C08L 77/02; C08L 51/06; C08L 23/06; C08L 25/06; B29C 48/00

(52) U.S. Cl. CPC C08L 77/06; C08L 77/02; C08L 51/06; C08L 2205/03; C08L 25/06; B29C 48/022; C08L 2205/025; C08L 23/06

(57) ABSTRACT

The invention relates to polyamide moulding compounds containing the following components (A) to (D) or consisting of these components: (A) between 50 and 98 wt. % of at least one polyamide selected from the group consisting of PA 516, PA 616, PA 1016 and mixtures thereof; (B) between 0 and 30 wt. % of at least one polyamide selected from the group consisting of PA 11, PA 12, PA 416, PA 516, PA 69, PA 610, PA 612, PA 614, PA 616, PA 618, PA 816, PA 1010, PA 1012, PA 1014, PA 1016, PA 1018, PA 1212, PA 1216, PA 1218 and mixtures thereof; (C) between 2 and 25 wt. % of at least one specific impact modifier; and (D) between 0 and 20 wt. % of at least one additive; the sum of the constituent amounts of the components (A) to (D) amounting to 100 wt. %.

The present invention relates to impact-modified polyamide moulding compounds which, in addition to a specific semi-crystalline polyamide selected from the group consisting of PA 516, PA 616, PA 1016 and mixtures thereof and a specific functionalised impact modifier, optionally comprise a further specific semi-crystalline polyamide and additives.

Furthermore, the present invention relates to moulded articles made of these polyamide moulding compounds, preferred moulded articles are thereby pipes and containers formed by extrusion.

Impact-modified polyamide moulding compounds and moulded articles thereof are already described in the state of the art.

EP 2 366 539 A1 relates to a two-layer plastic material pipe piece for pressure-impacted fluid pipes with an inner layer and with an outer layer. The inner layer is constructed from a first mixture which comprises an elastomeric copolyolefin or a blend of a semi-crystalline polyolefin and a synthetic olefinic rubber, and also a homopolyamide. The outer layer is constructed from a second mixture which comprises a homopolyamide. Such lines or pipes are used, inter alia, in industry and in automobile construction, thereby preferred are cooling pipes for automobiles.

EP 3 135 731 A1 relates to a polyamide moulding compound consisting of an amorphous, microcrystalline or semi-crystalline polyamide or mixtures hereof, at least one impact modifier, hollow glass balls and also further additives.

Starting herefrom, the object was to provide a polyamide moulding compound which has very good toughness, in particular expressed by the notch impact strength at room temperature and at low temperature and also the breaking elongation and which is furthermore also extrudable, the extruded moulded articles having a smooth surface.

This object is achieved by the polyamide moulding compound according to claim 1, which has the following features.

Polyamide moulding compound comprising the following components (A) to (D) or consisting of these components:
(A) 50 to 98% by weight of at least one polyamide selected from the group consisting of PA 516, PA 616, PA 1016 and mixtures thereof; the latter having a relative viscosity, determined in m-cresol, in the range of 1.8 to 2.5 and the content of amino end groups being in the range of 25 to 110 mmol/kg;
(B) 0 to 30% by weight of at least one polyamide selected from the group consisting of PA 11, PA 12, PA 416, PA 516, PA 69, PA 610, PA 612, PA 614, PA 616, PA 618, PA 816, PA 1010, PA 1012, PA 1014, PA 1016, PA 1018, PA 1212, PA 1216, PA 1218 and mixtures hereof; the latter having a relative viscosity, determined in m-cresol, in the range of 1.4 to 1.75 and the content of amino end groups being in the range of 80 to 175 mmol/kg;
(C) 2 to 25% by weight of at least one functionalised impact modifier selected from the group consisting of polyolefin copolymers, styrene copolymers, styrene block copolymers, ionic ethylene copolymers with acid groups, the latter being neutralised at least partially by metal ions, and mixtures hereof;
(D) 0 to 20% by weight of at least one additive;
   the quantity proportions of components (A) to (D) adding up in total to 100% by weight.

Preferred embodiments of the polyamide moulding compound according to the invention are indicated in the dependent claims 2 to 14.

Furthermore, the present invention relates to the moulded articles according to claim 15, preferred moulded articles are indicated in claim 16.

### Definitions of Terms

### Spellings and Abbreviations for Polyamides and the Monomers Thereof

In the sense of the present invention there is understood by the term “polyamide” (abbreviation PA), a generic term, the latter comprises homopolyamides and copolyamides. The chosen spellings and abbreviations for polyamides and the monomers thereof correspond to those established in the ISO Standard 16396-1 (2015, (D)). The abbreviations used therein are used synonymously, in the following, to the IUPAC names of the monomers.

In General with Respect to Quantity Details

The polyamide moulding compounds according to the present invention comprise components (A) and (C) and also possibly (B) and (D) or preferably consist exclusively of these, there thereby applies the proviso that components (A), (B), (C) and (D) add up in total to 100% by weight. The established ranges of the quantity details for the individual components (A), (B), (C) and (D) should be understood such that, within the prescribed ranges, an arbitrary quantity for each of the individual components can be selected provided the strict proviso is fulfilled that the sum of all components (A) to (D) produces 100% by weight.

### Functionalisation of Component (C)

Component (C) can be functionalised by copolymerisation or by grafting. In the sense of the present invention, functionalisation by copolymerisation means the incorporation of the functionalising compound into the main chain of component (C) as component of this main chain. There is understood, in contrast, by the functionalisation of component (C) by grafting, the binding of the functionalising compound to the main chain so that side chains are produced.

### Semi-Crystalline Polyamides

In the sense of the present invention, semi-crystalline polyamides are those polyamides which have a melting point. Furthermore, semi-crystalline polyamides in the sense of the present invention preferably have, in dynamic difference calorimetry (Differential Scanning calorimetry, DSC) according to ISO 11357-3 (2013), a melting heat of more than 4 J/g with a heating rate of 20 K/min.

### Polyamide Moulding Compound

The polyamide moulding compound according to the invention comprises components (A) and (C) and possibly (B) and/or (D) or consists of these.

According to a preferred embodiment of the present invention, the proportion of component (A) in the polyamide moulding compound is in the range of 55 to 88.9% by weight, preferably of 58 to 83.7% by weight and particularly preferably of 60 to 79.5% by weight, relative to the total weight of the polyamide moulding compound.

According to a further preferred embodiment of the present invention, the proportion of component (B) in the polyamide moulding compound is in the range of 5 to 25% by weight, preferably of 8 to 20% by weight and particularly preferably of 10 to 20% by weight, relative to the total weight of the polyamide moulding compound.

A further preferred embodiment provides that the proportion of component (C) in the polyamide moulding compound is in the range of 6 to 22% by weight, preferably of 8 to 20% by weight and particularly preferably of 10 to 20% by weight, relative to the total weight of the polyamide moulding compound.

A further preferred embodiment provides that the proportion of component (D) in the polyamide moulding compound is in the range of 0.1 to 10% by weight, preferably of 0.3 to 6% by weight and particularly preferably of 0.5 to 4% by weight, relative to the total weight of the polyamide moulding compound.

According to a preferred embodiment of the present invention, the proportion of component (A) in the polyamide moulding compound is in the range of 55 to 88.9% by weight, preferably of 58 to 83.7% by weight and particularly preferably of 60 to 79.5% by weight and the proportion of component (B) in the polyamide moulding compound is in the range of 5 to 25% by weight, preferably of 8 to 20% by weight and particularly preferably of 10 to 20% by weight and the proportion of component (C) in the polyamide moulding compound is in the range 6 to 22% by weight, preferably of 8 to 20% by weight and particularly preferably of 10 to 20% by weight and the proportion of component (D) in the polyamide moulding compound is in the range 0.1 to 10% by weight, preferably of 0.3 to 6% by weight and particularly preferably of 0.5 to 4% by weight, respectively relative to the total weight of the polyamide moulding compound.

According to a preferred embodiment of the present invention, a test piece made of the polyamide moulding compound according to the invention has
a elongation at break determined according to ISO 527 of at least 200%, preferably at least 220% and particularly preferably at least 250%; and/or
a modulus of elasticity in tension determined according to ISO 527 of at least 900 MPa, preferably at least 1,000 MPa and particularly preferably at least 1,100 MPa; and/or
a Charpy notch impact strength at 23° C. determined according to ISO 179/2eA of at least 75 kJ/m², preferably at least 80 kJ/m² and particularly preferably at least 90 kJ/m²; and/or
a Charpy notch impact strength at −40° C. determined according to ISO 179/2eA of at least 15 kJ/m², preferably at least 20 kJ/m² and particularly preferably at least 21 kJ/m².

Another preferred embodiment of the present invention provides that the MVR (melt volume rate) of the melt, determined according to ISO 1133-1 (2012), is in the range of 10 to 120 cm³/10 min, preferably of 15 to 100 cm³/10 min and particularly preferably of 20 to 90 cm³/10 min.

A further preferred embodiment of the present invention provides that the melt strength, determined as indicated in the experimental part, is in the range of 15 to 60 seconds and preferably of 18 to 55 seconds.

Provided the conditions are fulfilled according to both preceding embodiments, the polyamide moulding compound is extrudable.

According to a preferred embodiment of the present invention, the polyamide moulding compound comprises
PA 616 as component (A);
a polyamide selected from the group consisting of PA 12, PA 616, PA 1016 and mixtures thereof as component (B); and
a functionalised impact modifier selected from the group consisting of ethylene-propylene copolymers, ethylene-1-butene copolymers, ethylene-propylene-1-butene copolymers, styrene copolymers, styrene block copolymers and mixtures thereof as component (B).

According to a further preferred embodiment of the present invention, the polyamide moulding compound comprises
PA 616 as component (A);
a polyamide selected from the group consisting of PA 12, PA 616 and PA 1016 and mixtures thereof as component (B); and
a functionalised impact modifier selected from the group consisting of ethylene-propylene copolymers, ethylene-1-butene copolymers, styrene block copolymers and mixtures thereof as component (C).

According to another preferred embodiment of the present invention, the polyamide moulding compound comprises
PA 616 as component (A);
at least two polyamides selected from the group consisting of PA 12, PA 616 and PA 1016 thereof as component (B); and
a functionalised impact modifier selected from the group consisting of ethylene-propylene copolymers, ethylene-1-butene copolymers, ethylene-propylene-1-butene copolymers, styrene copolymers, styrene block copolymers and mixtures as component (C).

Another preferred embodiment provides that component (A) and component (B) are PA 616.

According to a further preferred embodiment of the present invention, component (A) is PA 616 and component (B) PA 1016.

According to a further preferred embodiment of the present invention, component (A) is PA 616 and component (B) PA 12.

Another preferred embodiment provides that component (A) is PA 616 and components (B) PA 616 and PA 12.

According to a further preferred embodiment of the present invention, component (A) and component (B) respectively are PA 1016.

According to a further preferred embodiment of the present invention, component (A) is PA 1016 and component (B) PA 616.

A further preferred embodiment of the present invention provides that component (A) is PA 616 and component (B) is not present.

Another preferred embodiment provides that component (A) and component (B) respectively is PA 616 and component (C) is selected from the group consisting of ethylene-propylene copolymers, ethylene-1-butene copolymers or ethylene-propylene-1-butene copolymers and mixtures thereof.

According to a further preferred embodiment of the present invention, component (A) is PA 616 and component (B) PA 616 and PA 12, and component (C) is selected from the group consisting of ethylene-propylene copolymers, ethylene-1-butene copolymers, ethylene-propylene-1-butene copolymers and mixtures thereof.

According to a further preferred embodiment of the present invention, component (A) and component (B) are PA 616 and component (C) is a styrene copolymer or styrene block copolymer.

Another preferred embodiment provides that component (A) is PA 616 and component (B) PA 1016 and component (C) is selected from the group consisting of ethylene-propylene copolymers, ethylene-1-butene copolymers, ethylene-propylene-1-butene copolymers and mixtures thereof.

According to a further preferred embodiment, the weight ratio of component (A) to component (B) is in the range of 95:5 to 60:40, preferably of 85:15 to 70:30 and particularly preferably of 80:20 to 72:28, respectively relative to 100 parts by weight as sum of (A) and (B).

According to a preferred embodiment, the moulding compound comprises precisely one polyamide (A) and precisely one polyamide (B).

In the following, preferred embodiments for components (A) to (D) are indicated.

### Component (A)

According to a preferred embodiment, component (A) has a relative viscosity in the range of 1.8 to 2.5, preferably of 1.90 to 2.30 and particularly preferably 1.95 to 2.25. The relative viscosity is thereby measured at 20° C. according to ISO 307 (2007) in a solution of 0.5 g polymer in 100 ml m-cresol.

According to a further preferred embodiment, the content of amino end groups of component (A) is in the range of 25 to 100 mmol/kg, preferably of 30 to 95 and particularly preferably of 40 to 90 mmol/kg.

Another preferred embodiment provides that the content of amino end groups of component (A) is higher than the content of carboxyl end groups of this component. For particular preference, the amino end groups are present in an excess of at least 15%, preferably of at least 20% and particularly preferably of at least 25%.

If component (A) is present in the form of mixture of a plurality of components, then the feature of the amino end group excess applies for the end groups of the entire mixture.

According to a further preferred embodiment, component (A) has a melting point of 170 to 205° C., preferably of 175 to 200° C., the melting point being determined by means of DSC according to ISO 11357-3 (2013) with a heating rate of 20 K/min.

Another preferred embodiment provides that component (A) is selected from the group consisting of PA 616, PA 1016 and mixtures hereof, PA 616 being particularly preferred.

### Component (B)

According to a preferred embodiment, component (B) has a relative viscosity in the range of 1.45 to 1.70 and preferably of 1.50 to 1.67. The relative viscosity is thereby measured according to ISO 307 (2007) at 20° C. in a solution of 0.5 g polymer in 100 ml m-cresol.

According to a further preferred embodiment, the content of amino end groups of component (B) is in the range of 85 to 150 mmol/kg and preferably of 90 to 125 mmol/kg.

According to a further preferred embodiment, component (B) has a melting point of 160 to 235° C., preferably of 170 to 225° C., particularly preferably of 175 to 210° C., the melting point being determined by means of DSC according to ISO 11357-3 (2013) with a heating rate of 20 K/min.

Another preferred embodiment provides that component (B) is selected from the group consisting of PA 11, PA 12, PA 69, PA 610, PA 612, PA 616, PA 1010, PA 1012, PA 1014, PA 1016, PA 1018, PA 1212 and mixtures hereof.

For particular preference, component (B) is selected from the group consisting of PA 12, PA 616, PA 1010, PA 1014, PA 1016 and mixtures hereof.

### Component (C)

The at least one functionalised impact modifier is selected from the group consisting of styrene copolymers, styrene block copolymers, ionic ethylene copolymers with acid groups, these being neutralised at least partially by metal ions and mixtures hereof.

According to a preferred embodiment of the present invention, the functionalisation of component (C) is effected by copolymerisation and/or by grafting. For this purpose, a compound is used particularly preferably, selected from the group consisting of unsaturated carboxylic acids, unsaturated carboxylic acid derivatives and mixtures hereof and/or unsaturated glycidyl compounds. This is selected, particularly preferably, from the group consisting of unsaturated carboxylic acid esters, in particular acrylic acid esters and/or methacrylic acid esters, unsaturated carboxylic acid anhydrides, in particular maleic anhydride, glycidylacrylic acid, glycidylmethacrylic acid, α-ethylacrylic acid, maleic acid, fumaric acid, itaconic acid, citraconic acid, aconitic acid, tetrahydrophthalic acid, butenylsuccinic acid and mixtures hereof.

If the functionalisation is effected by copolymerisation, the weight proportion of each individual compound used for the functionalisation is preferably in the range of 3 to 25%, particularly preferably of 4 to 20% by weight and particularly preferably of 4.5 to 15% by weight, respectively relative to the total weight of component (C).

Provided the functionalisation is effected by grafting, the weight proportion of each individual compound used for the functionalisation is preferably in the range of 0.3 to 2.5% by weight, particularly preferably of 0.4 to 2.0% by weight and particularly preferably of 0.5 to 1.9% by weight, respectively relative to the total weight of component (C).

Impact modifiers functionalised by copolymerisation can in addition be functionalised also by grafting.

The polyolefin copolymers are preferably selected from the group consisting of ethylene-α-olefin copolymers, propylene-α-olefin copolymers, ethylene-propylene copolymers, ethylene-propylene-diene copolymers and mixtures thereof, the α-olefins preferably having 3 to 18 carbon atoms. Particularly preferably, the α-olefins are selected from the group consisting of propene, 1-butene, 1-pentene, 1-hexene, 1-octene, 1-decene, 1-dodecene and mixtures thereof.

Examples of ethylene-α-olefin copolymers are linear polyethylenes with average densities in the range of 0.941 to 0.950 g/m³ (PE-LMD), linear polyethylenes with low densities in the range of 0.911 to 0.940 g/m³ (PE-LLD), linear polyethylenes with very low densities in the range of 0.900 to 0.910 g/m³ (PE-VLD), linear polyethylenes with ultralow densities in the range of 0.860 to 0.899 g/m³ (PE-ULD), ethylene copolymers or ethylene-1-butene copolymers.

Amongst the ethylene-α-olefin copolymers, ethylene-propylene copolymers, ethylene-1-butene copolymers or ethylene-propylene-1-butene copolymers are preferred.

Amongst the ethylene-propylene-1-butene copolymers, copolymers are preferred in which the monomers ethylene a), propylene b) and 1-butene c) are used in the following molar proportions:
a) ethylene: 65 to 90% by mol, preferably 65 to 87% by mol, particularly preferably 71 to 84% by mol;
b) propylene: 8 to 33% by mol, preferably 10 to 25% by mol, particularly preferably 12 to 20% by mol; and also
c) 1-butene: 2 to 25% by mol, preferably 3 to 20% by mol, particularly preferably 4 to 15% by mol, very particularly preferably 4 to 9% by mol;
   monomers a) to c) adding up to 100% by mol.

The styrene copolymers are preferably styrene copolymers with a comonomer selected from the group consisting of butadiene, isoprene, acrylate and mixtures thereof.

The styrene block copolymers are preferably selected from the group consisting of styrene-butadiene-styrene triblock copolymers (SBS), styrene-isoprene-styrene triblock colpolymers (SIS), styrene-ethylene/butylene-styrene triblock copolymer (SEBS), styrene-ethylene/propylene-styrene triblock copolymer (SEPS) and mixtures thereof.

The styrene-ethylene/butylene-styrene triblock copolymers concern linear triblock copolymers made of an ethylene/butylene block and two styrene blocks.

The styrene-ethylene/propylene-styrene triblock copolymers concern linear triblock copolymers made of an ethylene/propylene block and two styrene blocks.

The styrene proportion in the styrene-ethylene/butylene-styrene triblock copolymers or styrene-ethylene/propylene-styrene triblock copolymers is preferably from 20 to 45% by weight, particularly preferably from 25 to 40% by weight and very particularly preferably from 25 to 35% by weight.

The styrene-ethylene/butylene-styrene triblock copolymers have preferably a melt volume flow rate of 90 to 160 cm³/10 min, particularly preferably of 100 to 150 cm³/10 min and very particularly preferably of 110 to 140 cm³/10 min. The melt volume flow rate is thereby measured at 275° C. and 5 kg according to ISO 1133.

The ionic ethylene copolymers consist preferably of the monomers selected from the group consisting of ethylene, propylene, butylene, acrylic acid, acrylate, methacrylic acid, methacrylate and mixtures thereof, the acid groups being neutralised partially with metal ions, particularly preferred are ethylene-methacrylic acid copolymers or ethylene-methacrylic acid-acrylate copolymers in which the acid groups are neutralised partially with metal ions. The metal ions used for the neutralisation concern preferably sodium-, zinc-, potassium-, lithium-, magnesium ions and mixtures thereof, sodium-, zinc- and magnesium ions are particularly preferred.

Provided the copolymers used as impact modifier comprise dienes as monomers, they are used preferably in hydrated, crosslinked or vulcanised form in the polyamide moulding compounds according to the invention.

In a particularly preferred embodiment of the polyamide moulding compound according to the invention, the impact modifier is selected from the group consisting of
styrene-ethylene/butylene-styrene triblock copolymers with 20 to 45% by weight of styrene, grafted with 0.3 to 2.5% by weight of maleic anhydride;
ethylene-propylene-1-butene copolymers in which the monomers ethylene a), propylene b) and 1-butene c) are used in the following molar proportions:
a) ethylene: 65 to 90% by mol, preferably 65 to 87% by mol, particularly preferably 71 to 84% by mol;
b) propylene: 8 to 33% by mol, preferably 10 to 25% by mol, particularly preferably 12 to 20% by mol; and also
c) 1-butene: 2 to 25% by mol, preferably 3 to 20% by mol, particularly preferably 4 to 15% by mol, very particularly preferably 4 to 9% by mol;
the monomers a) to c) adding up to 100% by mol, and the ethylene-propylene-1-butene copolymers being grafted with 0.3 to 2.5% by weight of maleic anhydride;
ethylene-1-butene copolymers grafted with 0.3 to 2.5% by weight of maleic anhydride; and
mixtures hereof.

In a particularly preferred embodiment of the polyamide moulding compound according to the invention, the impact modifier is selected from the group consisting of
a styrene-ethylene/butylene-styrene triblock copolymer with 20 to 35% by weight of styrene, grafted with 1.4 to 1.9% by weight of maleic anhydride;
ethylene-propylene-1-butene copolymers consisting of 71 to 84% by mol of ethylene a), 12 to 20% by mol of propylene b) and also 4 to 9% by mol of 1-butene c), components a) to c) adding up to 100% by mol and the ethylene-propylene-1-butene copolymers being grafted with 0.3 to 0.9% by weight of maleic anhydride;
ethylene-1-butene copolymers grafted with 0.9 to 1.5% by weight of maleic anhydride; and
mixtures hereof.

In a further particularly preferred embodiment of the polyamide moulding compound according to the invention, the impact modifier is selected from the group consisting of
a styrene-ethylene/butylene-styrene triblock copolymer with 30% by weight of styrene, grafted with 1.7% by weight of maleic anhydride;
a blend of ethylene-propylene copolymer and ethylene-1-butene copolymer in the weight ratio 67:33, grafted with 0.6% by weight of maleic anhydride;
an ethylene-1-butene copolymer grafted with 1.2% by weight of maleic anhydride; and
mixtures thereof.

The at least one impact modifier according to component (C) can also be used in the form of a mixture or of a blend with one or more non-functionalised impact modifier according to component (D). According to a preferred embodiment, the polyamide moulding compounds according to the invention comprise however no non-functionalised impact modifiers.

### Component (D)

The additives according to component (D) are selected from the group consisting of inorganic and organic stabilisers, in particular antioxidants, antiozonants, light-protection means, in particular UV stabilisers, UV absorbers or UV blockers, metal deactivators, lubricants, colourants, marking means, pigments, carbon black, graphite, graphene, carbon nanotubes, photochromic agents, antistatic agents, mould-release means, condensation catalysts, chain regulators, defoamers, antiblocking means, chain-lengthening additives, optical brighteners, IR absorbers, NIR absorbers, halogen-containing flame retardants, halogen-free flame retardants, non-functionalised impact modifiers, natural layer silicates, synthetic layer silicates, metallic pigments, metal flakes, metal-coated particles, particulate fillers, fibrous fillers, nanoscale fillers with a particle diameter (d₉₅) of at most 100 nm, determined by means of laser diffraction according to ISO 13320 (2009) and mixtures thereof.

The layer silicates and fillers can be surface-treated. This can take place with a suitable size- or adhesive system. For this purpose, for example systems based on fatty acids, waxes, silanes, titanates, polyamides, urethanes, polyhydroxy ethers, epoxides, nickel, respectively combinations or mixtures thereof can be used.

With respect to the fibrous or reinforcing fillers, basically there are no restrictions. Preferably, these are selected from the group consisting of glass fibres, carbon fibres, metal fibres, aramide fibres, plant fibres, cellulose fibres, in particular nanocellulose fibres, polymer fibres, whiskers, mineral fibres and mixtures hereof.

As particulate fillers, all fillers known to the person skilled in the art are possible. There are included herein in particular particulate fillers selected from the group consisting of minerals, talc, mica, dolomite, silicates, quartz, titanium dioxide, wollastonite, kaolin, silicic acids, magnesium carbonate, magnesium hydroxide, chalk, ground glass, glass flakes, ground carbon fibres, aramide fibres, ground or precipitated calcium carbonate, lime, feldspar, barium sulphate, zinc sulphide, zinc oxide, permanent-magnetic or magnetisable metals or alloys, glass balls, hollow glass balls, hollow-ball silicate fillers and mixtures hereof.

Preferably, the additives according to component (D) are selected from the group consisting of inorganic and organic stabilisers, in particular antioxidants, antiozonants, light-protection means, in particular UV stabilisers, UV absorbers or UV blockers, lubricants, colourants, marking means, pigments, carbon black, graphite, photochromic agents, antistatic agents, mould-release means, antiblocking means, chain-lengthening additives, optical brighteners, IR absorbers, NIR absorbers, natural layer silicates, synthetic layer silicates, metal flakes, particulate fillers, fibrous fillers, nanoscale fillers with a particle diameter (d₉₅) of at most 100 nm, determined by means of laser diffraction according to ISO 13320 (2009), and mixtures thereof.

Particularly preferably, the additives according to component (D) are selected from the group consisting of inorganic stabilisers, organic stabilisers, in particular antioxidants, antiozonants and/or light-protection means, lubricants, colourants, marking means, inorganic pigments, organic pigments, carbon black, graphite, mould-release means, antiblocking means, chain-lengthening additives, optical brighteners, IR absorbers, NIR absorbers, particulate fillers, fibrous fillers and mixtures thereof.

### Moulded Articles

The moulded articles according to the invention are produced preferably via extrusion processes.

Particularly preferably, moulded articles are thereby selected from the group consisting of pipes and containers formed by means of extrusion. Preferred pipes are cooling pipes, in particular for engines or batteries, heating pipes, in particular in the interior of buildings or in batteries, ventilation pipes for the crankcase and urea pipes (e.g. AdBlue).

### Use

The polyamide moulding compound according to the invention is therefore suitable for use for the production of moulded articles selected from the group consisting of pipes and containers formed by means of extrusion.

Use for pipes and containers selected from the group consisting of pipes and containers formed by means of extrusion is thereby particularly preferred. Preferred pipes are cooling pipes, in particular for engines or batteries, heating pipes, in particular in the interior of buildings or in batteries, ventilation pipes for the crankcase and urea pipes, (e.g. AdBlue).

The subject according to the invention is intended to be explained in more detail with reference to the subsequent examples, without wishing to restrict said subject to the specific embodiments shown here.

### 1 MEASURING METHODS

Within the scope of this application, the following measuring methods were used.

### Relative Viscosity

The relative viscosity was determined according to ISO 307 (2007) at 20° C. For this purpose 0.5 g of polymer granulate was weighed into 100 ml of m-cresol, the calculation of the relative viscosity (RV) according to RV=t/to was effected following section 11 of the standard.

### Melting Point

Determination of the melting point was effected according to ISO 11357-3 (2013) on granulate.

Differential Scanning calorimetry (DSC) was implemented during each of the two heatings at a heating rate of 20 K/min. After the first heating, the sample was quenched in dry ice. The melting point was determined during the second heating.

The temperature at the peak maximum was indicated as melting point. The average of the glass transition region which was indicated as glass transition temperature (Tg) was determined according to the “Half Height” method.

### Modulus of Elasticity in Tension

Determination of the modulus of elasticity in tension was implemented, according to ISO 527 (2012), at 23° C. at a tensile speed of 1 mm/min on an ISO tensile bar (type A1, size 170×20/10×4), produced according to the standard: ISO/CD 3167 (2003).

### Elongation at Break

Determination of the elongation at break was implemented, according to ISO 527 (2012), at 23° C. at a tensile speed of 50 mm/min on an ISO tensile bar, type A1 (size 170×20/10×4 mm), produced according to the standard ISO/CD 3167 (2003).

### Notch Impact Strength According to Charpy

Determination of the notch impact strength according to Charpy was implemented, according to DIN EN ISO 179/2eA (2000), at 23° C. and −40° C. on an ISO test bar, type B1 (size 80×10×4 mm), produced according to the standard ISO/CD 3167 (2003).

### Melt Strength

There is understood by melt strength, the “stability” of the preform during extrusion. As already mentioned above, only those moulding compound, the melt strength of which is within a specific range, i.e. in a suitable processing window, are suitable for extrusion. The applicant has developed its own practice-related method according to which it is assessed whether the melt strength is within the mentioned range. In the case of this method, a melt hose is extruded continuously via an angle head. The time which the hose requires to cover the distance from the nozzle to the base is used as measuring variable. This distance is 112 cm in the case of the arrangement which is used. During the measurement of the melt strength, the operation takes place with constant ejection of 100 gram moulding compounds-melt per minute and with set cylinder-, mould- and nozzle temperatures of 260° C. The time measurement is started at the moment when the melt hose emerging continuously from an annular extrusion nozzle is cut off at the extrusion nozzle with a spatula. The time is stopped as soon as the newly emerging and downward traveling hose portion touches the base. A material which finds it difficult to bear the increasing inherent weight (due to the continuing extruded melt), i.e. begins to stretch in a viscous manner, will extend more and consequently the tip of the melt hose will touch the base earlier, i.e. the shorter measuring time corresponds to a lesser melt strength. The practical advantage of this method for determining the extrudability is that it is based not only on a single property observed in isolation, such as the molecular weight of the polyamide or a viscosity, but that also all further influencing variables, which are relevant for the behaviour of the extruded preform, influence the measured time automatically and in an integral manner.

### MVR (Melt Volume Rate) or MFR (Melt Flow Rate)

Determination of the MVR or MFR was effected according to ISO 1133-1 (2012), and in fact on the granulate of the moulding compounds of the examples or comparative examples at 275° C. and with a loading of 21.6 kg or on the granulate of the impact modifiers under the conditions indicated in table 1.

### End Groups (Amino- and Carboxy End Groups)

The amino- (NH₂) and carboxy (COOH) end group concentrations are determined by means of a potentiometric titration. For the amino end groups, for this purpose 0.2 to 1.0 g of polyamide is dissolved in a mixture of 50 ml m-cresol and 25 ml isopropanol at 50 to 90° C. and is titrated after addition of aminocaproic acid with a 0.05 molar perchloric acid solution. For determination of the COOH end groups, 0.2 to 1.0 g of the sample to be determined is dissolved, according to solubility in benzyl alcohol or in a mixture of o-cresol and benzyl alcohol at 100° C. and is titrated after addition of benzoic acid with a 0.1 molar tetra-n-butylammonium hydroxide solution.

### Optical Assessment of Extruded Moulded Articles

Assessment was effected by observation of the hose of the melt strength measurement with the naked eye without magnification:

+ smooth surface
− pimples in the surface
−− nodules is the surface

The surface of the pipes must be smooth, otherwise they are not usable.

### Production of the Test Pieces

The test pieces were produced on an injection moulding machine of the company Arburg, Modell Allrounder 320-210-750 Hydronica. Rising cylinder temperatures of 270° C. to 290° C. were thereby used.

The ISO tensile bars and ISO test bars were produced with a mould temperature of 30° C.

The test pieces, provided nothing else is indicated, were used in the dry state; for this purpose they were stored after injection moulding for at least 48 h at room temperature in dry surroundings, i.e. over silica gel.

### 2 STARTER MATERIALS

The materials used in the examples and comparative examples are combined in tables 1 and 2.

TABLE 1
Materials used in the examples and comparative examples.

| Component | Description | Manufacturer |
|---|---|---|
| Polyamide | semi-crystalline linear aliphatic polyamide made of 1,6- | EMS- |
| 616 (A) | hexanediamine and 1,16-hexadecanedioic acid | CHEMIE |
| | melting point 195° C. | AG, |
| | (A) RV 2.17; NH₂ 45 mmol/kg; COOH 19 mmol/kg | Switzerland |
| Polyamide | semi- crystalline linear aliphatic polyamide made of 1,6- | EMS- |
| 616 | hexanediamine and 1,16-hexadecanedioic acid | CHEMIE |
| carboxy end | melting point 195° C. | AG, |
| groups | RV 1.96; NH₂ 32 mmol/kg; COOH 56 mmol/kg | Switzerland |
| Polyamide | semi-crystalline linear aliphatic polyamide made of | EMS- |
| 12 (B) | laurinlactam | CHEMIE |
| | melting point 178° C. | AG, |
| | (B) RV 1.65; NH₂ 103 mmol/kg; COOH 7 mmol/kg | Switzerland |
| Polyamide | semi-crystalline linear aliphatic polyamide made of | EMS- |
| 12 RV210 | laurinlactam | CHEMIE |
| | melting point 178° C. | AG, |
| | RV 2.10; NH₂ 55 mmol/kg; COOH 8 mmol/kg | Switzerland |
| Polyamide | semi-crystalline linear aliphatic polyamide made of | EMS- |
| 12 RV225 | laurinlactam | CHEMIE |
| | melting point 178° C. | AG, |
| | RV 2.25; NH₂ 24 mmol/kg; COOH 26 mmol/kg | Switzerland |
| Impact | blend of ethylene/propylene copolymer and ethylene/1- | Mitsui |
| modifier (C1) | butene copolymer in the weight ratio 67:33 | Chemicals, |
| | 0.6% by wt. of maleic anhydride | Japan |
| | MVR* 1.3 cm³/10 min at 230° C. and 2.16 kg | |
| | density 0.875 g/cm³ | |
| | trade name Tafmer MC201 | |
| Impact | ethylene/1-butene copolymer | Mitsui |
| modifier(C2) | MFR** 2.2 g/10 min at 230° C. and 2.16 kg | Chemicals, |
| | density 0.885 g/cm³ | Japan |
| | trade name Tafmer DF810 | |
| Impact | functionalised styrene-ethylene/butylene-styrene | Kraton |
| modifier(C3) | block copolymer with 30% by wt. of styrene | Polymers |
| | 1.7% by wt. of maleic anhydride | LLC, USA |
| | MVR* 130 cm³/10 min at 175° C. and 5 kg | |
| | density 0.91 g/cm³ | |
| | trade name Kraton FG1901 GT | |
| Impact | zinc ionomer based on ethylene-methacrylic acid | DuPont de |
| modifier(C4) | copolymer MFR** 0.8 g/10 min at 190° C. and 2.16 kg | Nemours |
| | density 0.96 g/cm³ | International S.A., |
| | trade name Surlyn 9320 | Switzerland |
| Impact | ethylene-tert.-butylacrylate-acrylic acid | LyondellBasel |
| modifier(C5) | copolymer | Industries |
| | MFR** 7.0 g/10 min at 190° C. and 2.16 kg | N.V., |
| | density 0.927 g/cm³ | Netherlands |
| | trade name Lucalen A2920M | |

RV: relative viscosity, measured on a solution of 0.5 g polyamide in 100 ml m-cresol at 20° C.
*melt volume rate,
**melt flow rate
NH₂ amino end groups,
COOH carboxy groups

TABLE 2
Additives used.

| | | Trade | |
|---|---|---|---|
| Component | Description | name | Manufacturerer |
| Antioxidant 1 | bis[3,3-bis-(4′hydroxy-3′-tert- | Hostanox O 3 P | Clariant Produkte |
| | butyl-phenyl)butanoic | | (Deutschland) |
| | acid]glycol ester | | GmbH, Germany |
| | CAS-No. 32509-66-3 | | |
| Antioxidant 2 | tetrakis(2,4-di-tert- | Hostanox P- EPQ | Clariant Produkte |
| | butylphenyl)-4,4′- biphenyl- | | (Deutschland) |
| | diphosphonite | | GmbH, Germany |
| | CAS-No. 119345-01-6 | | |
| Lubricant | magnesium stearate | Magnesium stearate | Bärlocher |
| | | AV | GmbH, Germany |
| Black | carbon black masterbatch based | Euthylen Schwarz | BASF Color Solutions, |
| masterbatch | on polyethylene | 00-6005 C4 | Germany |
| | with 40% by wt. of carbon black | | |

All examples and comparative examples comprise 1.75% by weight of additives which are composed as follows: antioxidant 1 0.8% by weight, antioxidant 2 0.1% by weight, lubricant 0.1% by weight and black masterbatch 0.75% by weight.

### 3 EXAMPLES AND COMPARATIVE EXAMPLES

### 3.1 General Production- and Processing Specification for the Polyamide Moulding Compounds

For the production of the polyamide moulding compounds according to the invention, components (A) and (C) and possibly (B) and/or (D) are mixed on normal compounding machines, such as e.g. single- or twin-screw extruders or screw kneaders. The components are thereby supplied individually via gravimetric metering scales into the feed or respectively into a sidefeeder or are supplied in the form of a dry blend.

If additives (component (D)) are used, these can be introduced directly or in the form of a masterbatch. The carrier material of the masterbatch preferably concerns a polyamide or a polyolefin. Amongst the polyamides, particularly the polyamide of the respective components A is suitable for this purpose.

For the dry blend production, the dried granulates of components (A), (C) and possibly (B) and possibly further additives (component (D)) are mixed in a closed container. This mixture is homogenised by means of a tumble mixer, eccentric wheel mixer or tumble drier for 10 to 40 minutes. In order to avoid absorption of moisture, this can be effected under dry protective gas.

The compounding is effected at set cylinder temperatures of 250 to 310° C., the temperature of the first cylinder being able to be adjusted below 90° C. Degassing can take place in front of the nozzle. This can be effected by means of vacuum or atmospherically. The melt is discharged in strand form, cooled in the water bath at 10 to 80° C. and subsequently granulated. The granulate is dried at 80 to 120° C. under nitrogen or in a vacuum to a water content of below 0.1% by weight.

Processing of the polyamide moulding compounds according to the invention in injection moulding is effected at cylinder temperatures of 260 to 310° C., a temperature profile which rises and falls from the feed towards the nozzle being able to be used. The mould temperature is adjusted to a temperature of 15 to 60° C., preferably 20 to 40° C.

### 3.2 Production of the Polyamide Moulding Compound According to Example 1

The dried granulates (A), (B) and (C) were mixed with the additives (D) to form a dry blend, and in fact in the ratio indicated in table 3. This mixture was homogenised by means of a tumble mixer for approx. 20 minutes.

The polyamide moulding compound was produced on a twin-screw extruder of the company Werner & Pfleiderer type ZSK 25. The dry blend was thereby metered into the feed via metering scales.

The temperature of the first housing was adjusted to 50° C., for the remaining housings a temperature profile rising and falling from 260° C. via 300° C. to 280° C. was used. A speed of rotation of 250 rpm and a throughput of 14 kg/h was used and degassing took place atmospherically. The melt strand was cooled in the water bath, cut and the obtained granulate was dried at 110° C. for 24 h in a vacuum (30 mbar) to a water content of below 0.1% weight.

### 3.3 Examples and Comparative Examples

In the following table 3, the results of the examples and comparative examples according to the present invention are compiled. The extrudability of the polyamide moulding compounds was thereby assessed via the MVR and via the melt strength. For extrudable polyamide moulding compounds, the MVR is in the range of 10 to 120 cm³/10 min, preferably of 15 to 100 cm³/10 min and particularly preferably 20 to 90 cm³/10 min and the melt strength is in the range of 15 to 60 seconds and preferably 18 to 55 seconds. The optical assessment was implemented on extruded hoses, as described under point 1.

TABLE 3
Examples and comparative examples.

| | | Examples and comparative examples | | | | | | |
|---|---|---|---|---|---|---|---|---|
| | Unit | E1 | CE2 | CE3 | E4 | CE5 | E6 | CE7 |
| Components | | | | | | | | |
| PA 616 (A) | % by wt. | 78.25 | — | — | 58.25 | — | 78.25 | — |
| PA 616 carboxy | % by wt. | — | — | — | — | — | — | — |
| end gr. | | | | | | | | |
| PA 12 RV210 | % by wt. | — | 78.25 | — | — | 58.25 | — | 78.25 |
| PA 12 (B) | % by wt. | — | — | — | 20 | 20 | — | — |
| PA 12 RV225 | % by wt. | — | — | 78.25 | — | — | — | — |
| Impact mod. (C1) | % by wt. | 20 | 20 | 20 | 20 | 20 | — | — |
| Impact mod. (C2) | % by wt. | — | — | — | — | — | — | — |
| Impact mod. (C3) | % by wt. | — | — | — | — | — | 20 | 20 |
| Impact mod. (C4) | % by wt. | — | — | — | — | — | — | — |
| Impact mod. (C5) | % by wt. | — | — | — | — | — | — | — |
| Additives | % by wt. | 1.75 | 1.75 | 1.75 | 1.75 | 1.75 | 1.75 | 1.75 |
| Measured values | | | | | | | | |
| Extrudability | — | yes | yes | yes | yes | no | yes | no |
| Optical | — | + | + | + | + | + | + | − |
| assessment | | | | | | | | |
| Modulus of | MPa | 1,150 | 1,000 | 1,010 | 1,020 | 1,020 | 1,150 | 1,070 |
| elasticity in | | | | | | | | |
| tension | | | | | | | | |
| Elongation | % | 250 | 220 | 190 | 310 | 220 | 220 | 200 |
| at break | | | | | | | | |
| Notch impact | | | | | | | | |
| strength | | | | | | | | |
| 23° C. | kJ/m² | 92 | 68 | 48 | 90 | 73 | 80 | 56 |
| −40° C. | kJ/m² | 21 | 17 | 14 | 20 | 16 | 21 | 17 |

| | Examples and comparative examples | | | | | | |
|---|---|---|---|---|---|---|---|
| | CE8 | E9 | CE10 | E11 | E12 | CE13 | CE14 |
| Components | | | | | | | |
| PA 616 (A) | — | 78.25 | — | 58.25 | 78.25 | 78.25 | — |
| PA 616 carboxy | — | — | — | 20 | — | — | — |
| end gr. | | | | | | | |
| PA 12 RV210 | — | — | 78.25 | — | — | — | 78.25 |
| PA 12 (B) | — | — | — | — | — | — | — |
| PA 12 RV225 | 78.25 | — | — | — | — | — | — |
| Impact mod. (C1) | — | — | — | 20 | 10 | — | — |
| Impact mod. (C2) | — | — | — | — | 10 | — | — |
| Impact mod. (C3) | 20 | — | — | — | — | — | — |
| Impact mod. (C4) | — | 20 | 20 | — | — | — | — |
| Impact mod. (C5) | — | — | — | — | — | 20 | 20 |
| Additives | 1.75 | 1.75 | 1.75 | 1.75 | 1.75 | 1.75 | 1.75 |
| Measured values | | | | | | | |
| Extrudability | no | yes | no | yes | yes | yes | no |
| Optical | −− | + | −− | + | + | − | −− |
| assessment | | | | | | | |
| Modulus of | 1,050 | 1,140 | 1,100 | 1,170 | 1,190 | 1,260 | 1,290 |
| elasticity in | | | | | | | |
| tension | | | | | | | |
| Elongation | 200 | 270 | 160 | 280 | 270 | 220 | 130 |
| at break | | | | | | | |
| Notch impact | | | | | | | |
| strength | | | | | | | |
| 23° C. | 25 | 129 | 124 | 91 | 90 | 13 | 27 |
| −40° C. | 11 | 22 | 18 | 22 | 19 | 11 | 10 |

+: smooth surface, −: pimples in the surface, −−: nodules in the surface.

### 4 DISCUSSION OF THE RESULTS

It can be deduced from table 3 that the polyamide moulding compounds according to the invention have improved notch impact strengths and breaking elongations and furthermore are extrudable and the extruded hoses have a smooth surface.

The polyamide moulding compounds according to example E1 according to the invention and comparative examples CE1 and CE2 comprise the same impact modifier in the same quantities. Both the breaking elongation and the notch impact strength at 23° C. and −40° C. are significantly higher for the polyamide moulding compounds according to the invention. This improvement is attributable to the exchange of polyamide 12 for the polyamide 616 according to the invention as component (A). The same tendencies can be deduced from comparison of E4 with CE5, E6 with CE7 and CE8 and also E9 with CE10. In the examples to be compared, respectively the same impact modifier was used for the process respectively in the same quantities and only the polyamide according to the invention for component (A) was exchanged. It was shown thereby in addition that the polyamide moulding compounds according to the comparative examples were generally not extrudable and/or had poor optical properties. The polyamide moulding compounds according to the invention, in contrast, displayed good optical properties, i.e. a smooth surface and were extrudable.

The comparative examples CE13 and CE14 were implemented with an impact modifier not according to the claim. Although in CE13, a polyamide according to the claim was used, only poor values for the notch impact strength could be achieved. Furthermore, the obtained polyamide moulding compound was in fact extrudable, however had defects (pimples) in the surface.

1-16. (canceled)

17. A polyamide moulding compound comprising components (A) to (D):
(A) 55 to 88.9% by weight of at least one polyamide selected from the group consisting of PA 516, PA 616, PA 1016 and mixtures thereof; the latter having a relative viscosity, determined in m-cresol, in the range of 1.8 to 2.5 and the content of amino end groups being in the range of 25 to 110 mmol/kg;
(B) 5 to 25% by weight of at least one polyamide selected from the group consisting of PA 11, PA 12, PA 416, PA 516, PA 69, PA 610, PA 612, PA 614, PA 616, PA 618, PA 816, PA 1010, PA 1012, PA 1014, PA 1016, PA 1018, PA 1212, PA 1216, PA 1218, and mixtures thereof; said polyamide having a relative viscosity, determined in m-cresol, in the range of 1.4 to 1.75 and the content of amino end groups being in the range of 80 to 175 mmol/kg;
(C) 6 to 22% by weight of at least one functionalised impact modifier selected from the group consisting of polyolefin copolymers, styrene copolymers, styrene block copolymers, ionic ethylene copolymers with acid groups, the latter being neutralised at least partially by metal ions, and mixtures thereof; and
(D) 0.1 to 20% by weight of at least one additive;
the quantity proportions of components (A) to (D) adding up in total to 100% by weight.

18. The polyamide moulding compound according to claim 17, wherein the proportion of component (A) in the polyamide moulding compound is in the range of 58 to 83.7% by weight, relative to the total weight of the polyamide moulding compound; and/or
the proportion of component (B) in the polyamide moulding compound is in the range of 8 to 20% by weight, relative to the total weight of the polyamide moulding compound; and/or
the proportion of component (C) in the moulding compound is in the range of 8 to 20% by weight, relative to the total weight of the polyamide moulding compound; and/or
the proportion of component (D) in the moulding compound is in the range of 0.1 to 10% by weight, relative to the total weight of the polyamide moulding compound.

19. The polyamide moulding compound according to claim 17, wherein the weight ratio of component (A) to component (B) is in the range of 95:5 to 60:40, respectively relative to 100 parts by weight as sum of (A) and (B).

20. The polyamide moulding compound according to claim 17, wherein component (A) has a relative viscosity, determined in m-cresol, in the range of 1.8 to 2.5, and/or
the content of amino end groups of component (A) is in the range of 25 to 100 mmol/kg, and/or
component (B) has a relative viscosity, determined in m-cresol, in the range of 1.45 to 1.70, and/or
the content of amino end groups of component (B) is in the range of 85 to 150 mmol/kg.

21. The polyamide moulding compound according to claim 17, wherein
component (A) is selected from the group consisting of PA 616, PA 1016, and mixtures thereof; and/or
component (B) is selected from the group consisting of PA 11, PA 12, PA 69, PA 610, PA 612, PA 616, PA 1010, PA 1012, PA 1014, PA 1016, PA 1018, PA 1212, and mixtures thereof.

22. The polyamide moulding compound according to claim 17, wherein the functionalisation of component (C) is effected by copolymerisation and/or by grafting.

23. The polyamide moulding compound according to claim 22, wherein the copolymerisation and/or by grafting is effected with a compound selected from the group consisting of unsaturated carboxylic acids, unsaturated carboxylic acid derivatives and mixtures thereof, and/or unsaturated glycidyl compounds.

24. The polyamide moulding compound according to claim 23, wherein the copolymerisation and/or by grafting is effected with a compound selected from the group consisting of unsaturated carboxylic acid esters, unsaturated carboxylic acid anhydrides, glycidylacrylic acid, glycidylmethacrylic acid, α-ethylacrylic acid, maleic acid, fumaric acid, itaconic acid, citraconic acid, aconitic acid, tetrahydrophthalic acid, butenylsuccinic acid and mixtures thereof.

25. The polyamide moulding compound according to claim 22, wherein, if the functionalisation is effected by copolymerisation, the weight proportion of each individual compound used for the functionalisation being in the range of 3 to 25% by weight, respectively relative to the total weight of component (C); and
if the functionalisation is effected by grafting, the weight proportion of each individual compound used for the functionalisation being preferably in the range of 0.3 to 2.5% by weight, respectively relative to the total weight of component (C).

26. The polyamide moulding compound according to claim 17, wherein component (C) is formed from at least one polyolefin copolymer; and/or
component (C) is formed from at least one styrene copolymer; and/or
component (C) is formed from at least one styrene block copolymer; and/or
component (C) is formed from at least one ionic ethylene copolymer.

27. The polyamide moulding compound according to claim 17, wherein component (A) is PA 616; and
component (B) is selected from the group consisting of PA 12, PA 616, PA 1016, and mixtures thereof; and
component (C) is selected from the group consisting of ethylene-propylene copolymers, ethylene-1-butene copolymers, ethylene-propylene-1-butene copolymers, styrene copolymers, styrene block copolymers, and mixtures thereof.

28. The polyamide moulding compound according to claim 17, wherein component (A) is PA 616; and
component (B) is selected from the group consisting of PA 12, PA 616, PA 1016 and mixtures thereof; and
component (C) is selected from the group consisting of ethylene-propylene copolymers, ethylene-1-butene copolymers, styrene block copolymers, and mixtures thereof.

29. The polyamide moulding compound according to claim 17, wherein component (A) is PA 616;
components (B) are at least two polyamides selected from the group consisting of PA 12, PA 616, and PA 1016; and
component (C) is selected from the group consisting of ethylene-propylene copolymers, ethylene-1-butene copolymers, ethylene-propylene-1-butene copolymers, styrene copolymers, styrene block copolymers, and mixtures thereof.

30. The polyamide moulding compound according to claim 17, wherein component (A) and component (B) respectively are PA 616; or
component (A) is PA 616 and component (B) is PA 1016; or
component (A) is PA 616 and component (B) is PA 12; or
component (A) is PA 616 and component (B) is PA 616 and PA 12; or
component (A) is PA 1016 and component (B) is PA 1016;
or
component (A) is PA 1016 and component (B) is PA 616; or
component (A) is PA 616, component (B) is PA 616, and component (C) is selected from the group consisting of ethylene-propylene copolymers, ethylene-1-butene copolymers or ethylene-propylene-1-butene copolymers, and mixtures thereof; or
component (A) is PA 616, component (B) is PA 616 or PA 12, and component (C) is selected from the group consisting of ethylene-propylene copolymers, ethylene-1-butene copolymers, ethylene-propylene-1-butene copolymers, and mixtures thereof; or
component (A) is PA 616 and component (B) is PA 616, and component (C) is a styrene copolymer or styrene block copolymer; or
component (A) is PA 616, component (B) is PA 1016, and component (C) is selected from the group consisting of ethylene-propylene copolymers, ethylene-1-butene copolymers, ethylene-propylene-1-butene copolymers, and mixtures thereof; or
component (A) is PA 1016, component (B) is PA 1016, and component (C) is selected from the group consisting of ethylene-propylene copolymers, ethylene-1-butene copolymers, ethylene-propylene-1-butene copolymers, and mixtures thereof.

31. The polyamide moulding compound according to claim 17, wherein the additives (D) are selected from the group consisting of inorganic and organic stabilisers, antiozonants, light-protection means, lubricants, colourants, marking means, pigments, carbon black, graphite, graphene, carbon nanotubes, photochromic agents, antistatic agents, mould-release means, condensation catalysts, chain regulators, defoamers, antiblocking means, chain-lengthening additives, optical brighteners, IR absorbers, NIR absorbers, halogen-containing flame retardants, halogen-free flame retardants, non-functionalised impact modifiers, natural layer silicates, synthetic layer silicates, metallic pigments, metal flakes, metal-coated particles, particulate fillers, fibrous fillers, nanoscale fillers with a particle diameter (d₉₅) of at most 100 nm, determined by means of laser diffraction according to ISO 13320 (2009), and mixtures thereof.

32. The polyamide moulding compound according to claim 17, wherein the polyamide moulding compound comprises precisely one polyamide as component (A) and precisely one polyamide as component (B).

33. The polyamide moulding compound according to claim 17, wherein a test piece produced from the polyamide moulding compound has an elongation at break, determined according to ISO 527, of at least 200%; and/or
has a modulus of elasticity in tension, determined according to ISO 527, of at least 900 MPa; and/or
has a Charpy notch impact strength at 23° C., determined according to ISO 179/2eA, of at least 75 kJ/m²; and/or
has a Charpy notch impact strength at −40° C., determined according to ISO 179/2eA of at least 15 kJ/m².

34. A moulded article comprising a polyamide moulding compound according to claim 17.

35. The moulded article according to claim 34, which is selected from the group consisting of pipes and containers.
